(19) United States
(12) Patent Application Publication
(10) Pub. No.: US 2012/0328741 A1
(43) Pub. Date: Dec. 27, 2012

(54) DRINKING STRAW AND STIRRING DEVICE WITH AN ADDITIVE AND METHOD THEREFOR

(76) Inventors: Mark Hannah, Ashland, KY (US); Linda McClenny, Tuscaloosa, AL (US)

(21) Appl. No.: 13/337,380

(22) Filed: Dec. 27, 2011

Related U.S. Application Data
(60) Provisional application No. 61/427,304, filed on Dec. 27, 2010.

(51) Int. Cl. A47G 21/18; A23L 2/52

(52) U.S. Cl. 426/85

(57) ABSTRACT

A device for drinking and adding a substance to a beverage has a tubular section having a first open end and a second open end. An additive is placed in an interior of the tubular section. A device is used for sealing the first open end and the second open end.

### RELATED APPLICATION

The present patent application is related to U.S. Provisional Application Ser. No. 61/427,304, filed Dec. 27, 2010, in the name of the same inventor, and entitled, “The Healthy Straw”. The present patent application claims the benefit under 35 U.S.C. §119(e).

### BACKGROUND

Embodiments of this disclosure generally relate to a drinking straw, and more particularly, to a drinking straw having an additive stored within the drinking straw which may be added to a drink.

Drinking straws are commonly used to consume beverages. Drinking straws generally comprise an elongate cylindrical sleeve through which a liquid/semi-liquid beverage may be consumed. In general, one end of the straw is submerged within the beverage to be consumed, the other end may be placed in a user's mouth to draw the beverage through the straw into the user's mouth.

It is desirable for some people to add different additives to their beverage. Some of these additives may include, but is not limited to: favoring, vitamins, protein enhancers, medication, and the like. Presently, in order to do this, the additive need to be bought in bulk and placed in the beverage. A spoon or other mixing device may then be used to mix the additive into the beverage.

However, it is desirable to provide a device that permits the additive, the mixing mechanism and the drinking mechanism to be incorporated into a single device. It is further desirable to provide a device that permits the uniform mixing and dissolving of the additive into the beverage.

### SUMMARY

A device for drinking and adding a substance to a beverage has a tubular section having a first open end and a second open end. An additive is placed in an interior of the tubular section. A device is used for sealing the first open end and the second open end.

A device for drinking and adding a substance to a beverage has a tubular section having a first open end and a second open. A spoon section extends down from the second open end, wherein the spoon section is folded upward closing the second open end. An additive is placed in an interior of the tubular section.

A device for drinking and adding a substance to a beverage has a tubular section having a first open end and a second open end. An additive is placed in an interior of the tubular section. A pair of end caps is used for sealing the first open end and the second open end.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated perspective of the drinking straw of the present invention with the stirring section in the extend position;

FIG. 2 is an elevated perspective of the drinking straw of the present invention with the stirring section in the closed position;

FIG. 3 is an elevated perspective of the drinking straw of the present invention with the stirring section in the closed position and sealed in a container;

FIG. 4 is elevated perspective of another embodiment of the drinking straw of the present invention.

### DETAILED DESCRIPTION

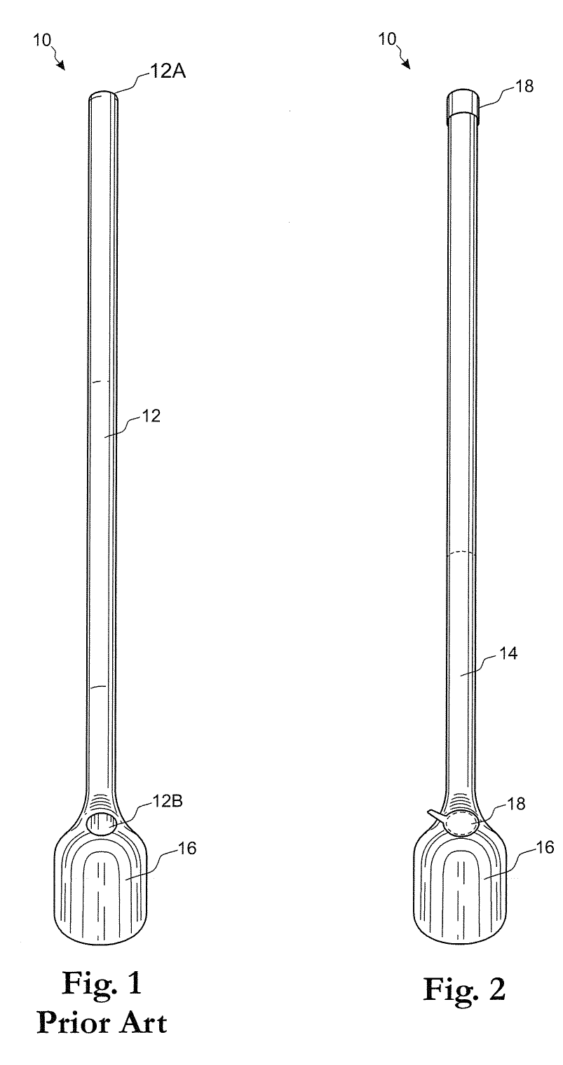

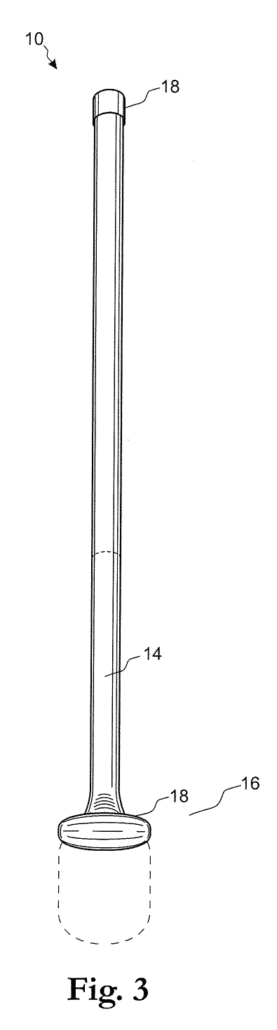

Turning to FIGS. 1-3, one embodiment of a drinking straw 10 of the present invention is shown. The drinking straw 10 may be formed of a tubular section 12. The tubular section 12 may have an open first end 12A and an open second end 12B. The tubular section 12 may be formed of a flexible plastic material such as polypropylene and polystyrene or the like. The listing of materials is given as an example and should not be seen in a limiting manner.

The tubular section 12 may be configured to house a predetermined amount of an additive 14. Thus, the length of the tubular section 12 and the diameter of the tubular section 12 may be configures to house a desired amount of additive 14 to be mixed with a predetermined amount of a beverage/liquid.

The additive 14 may be any type of additive such as, but not limited to: favoring, vitamins, minerals, electrolytes, juices, carbonated drink mixes, special mixtures of ingredients designed to be very suitable for diabetics and people suffering from obesity or other medical issues, protein enhancers, medication, and the like. The additive 14 may be a liquid, a powder, or the like. In accordance with one embodiment, the additive may be an all natural, sugar free, preservative free and stabilizer free ingredients that is in powder form.

Extending down from the open second end 12B of the tubular section 12 is a spoon member 16. The spoon member 16 may be formed of the same and or similar material as the tubular section 12, i.e., flexible plastic material such as polypropylene and polystyrene. The spoon member 16 may be oval in shape and have a slight curve and or bend.

Once the additive 14 is placed in an interior of the tubular section 12, the open first end 12A and an open second end 12B may be sealed. In accordance with the embodiment shown in FIGS. 1-3, the spoon member 16 may be folded upward to close the open second end 12B. A removable seal 18 may be placed over the folded spoon member 16 to keep the spoon member folded upward and to ensure that the additive 14 does not leak out.

A removable seal 18 may also be placed over the open first end 12A. The removable seal 18 may be used to ensure that the additive 14 does not leak out of the tubular section 12.

The drinking straw 10 may be placed in a container 18. The container 20 may be a sealed type container 20 to prevent tampering. In accordance with one embodiment, the container 20 may be a vacuumed sealed container 18.

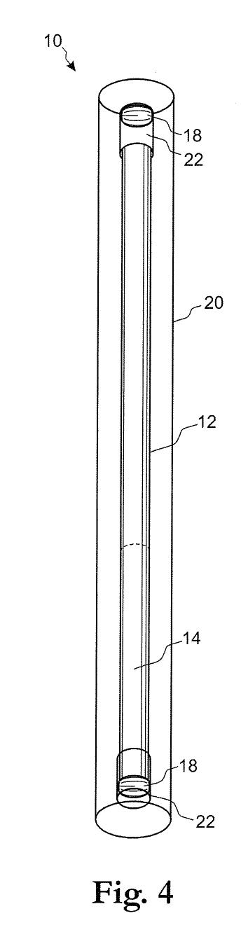

Referring now to FIG. 4, another embodiment of the drinking straw 10′ is shown. In this embodiment, the drinking straw 10′ may be formed of a tubular section 12. The tubular section 12 may have an open first end 12A and an open second end 12B. The tubular section 12 may be formed of a flexible plastic material such as polypropylene and polystyrene or the like. The listing of materials is given as an example and should not be seen in a limiting manner.

The tubular section 12 may be configured to house a predetermined amount of an additive 14. Thus, the length of the tubular section 12 and the diameter of the tubular section 12 may be configures to house a desired amount of additive 14 to be mixed with a predetermined amount of a beverage/liquid.

The additive 14 may be any type of additive such as, but not limited to: favoring, vitamins, minerals, electrolytes, juices, carbonated drink mixes, special mixtures of ingredients designed to be very suitable for diabetics and people suffering from obesity or other medical issues, protein enhancers, medication, and the like. The additive 14 may be a liquid, a powder, or the like. In accordance with one embodiment, the additive may be an all natural, sugar free, preservative free and stabilizer free ingredients that is in powder form.

In this embodiment, end caps 22 may be placed over the open first end 12A and an open second end 12B. The end caps 22 may be used to ensure that the additive 14 does not leak out. A removable seal 18 may be placed over the end caps 20. The removable seal 18 may be used to ensure that the end caps 20 remain on the tubular section 12.

The drinking straw 10′ may be placed in a container 20. The container 20 may be a sealed type container 20 to prevent tampering. In accordance with one embodiment, the container 20 may be a vacuumed sealed container 20.

In use, the drinking straw 10 or 10′ may be removed from the container 20. The removable seal 18 may be removed from the spoon member 16 which has been folded upward or the end cap 22 placed over the open second end 12B. The additive 14 may then be poured into the beverage. The user may then stir the beverage to mix the additive 14 into the beverage. If the drinking straw 10 is used, the spoon member 16 in combination with the tubular section 12 may be used to stir the beverage to mix the additive 14 into the beverage. If the drinking straw 10 is used, the tubular section 12 alone may be used to stir the beverage to mix the additive 14 into the beverage. The removable seal 18 may be removed from the open end 12A for drinking straw 10 or from the end caps 22 covering the open end 12A in drinking straw 10′. The user may then consume the beverage through the drinking straw 10 or the drinking straw 10′.

While embodiments of the disclosure have been described in terms of various specific embodiments, those skilled in the art will recognize that the embodiments of the disclosure may be practiced with modifications within the spirit and scope of the claims.

What is claimed is:

1. A device for drinking and adding a substance to a beverage comprising:
a tubular section having a first open end and a second open end;
an additive placed in an interior of the tubular section; and
a device for sealing the first open end and the second open end.

2. A device for drinking and adding a substance to a beverage in accordance with claim 1 wherein the device for sealing the first open end is a first removable seal positioned across the first open end.

3. A device for drinking and adding a substance to a beverage in accordance with claim 2 wherein the device for sealing the second open comprises:
a spoon section extending down from the second open end, wherein the spoon section is folded upward closing the second open end; and
a second removable seal positioned across the spoon section, the second removable seal securing the spoon section folded upward.

4. A device for drinking and adding a substance to a beverage in accordance with claim 3 further comprising an enclosure for storing the device.

5. A device for drinking and adding a substance to a beverage in accordance with claim 3 further comprising an air tight enclosure for storing the device.

6. A device for drinking and adding a substance to a beverage in accordance with claim 1 wherein the device for sealing the first open end and a second open end comprises a pair of end caps.

7. A device for drinking and adding a substance to a beverage in accordance with claim 6 further comprising removable seals positioned across the end caps to secure the end caps to the tubular section.

8. A device for drinking and adding a substance to a beverage in accordance with claim 7 further comprising an air tight enclosure for storing the device.

9. A device for drinking and adding a substance to a beverage comprising:
a tubular section having a first open end and a second open end;
a spoon section extending down from the second open end, wherein the spoon section is folded upward closing the second open end; and
an additive placed in an interior of the tubular section.

10. A device for drinking and adding a substance to a beverage in accordance with claim 9 further comprising a first removable seal positioned across the first open end.

11. A device for drinking and adding a substance to a beverage in accordance with claim 10 further comprising a second removable seal positioned across the spoon section, the second removable seal securing the spoon section folded upward.

12. A device for drinking and adding a substance to a beverage in accordance with claim 11 further comprising an enclosure for storing the device.

13. A device for drinking and adding a substance to a beverage comprising:
a tubular section having a first open end and a second open end;
an additive placed in an interior of the tubular section; and
a pair of end caps for sealing the first open end and the second open end.

14. A device for drinking and adding a substance to a beverage in accordance with claim 13 further comprising removable seals positioned across the end caps to secure the end caps to the tubular section.

15. A device for drinking and adding a substance to a beverage in accordance with claim 14 further comprising an air tight enclosure for storing the device.
